(19) United States
(12) Patent Application Publication
(10) Pub. No.: US 2012/0198347 A1
(43) Pub. Date: Aug. 2, 2012

(54) METHOD AND APPARATUS FOR ENHANCING USER BASED CONTENT DATA

(75) Inventors: Ari-Pekka Hirvonen, Helsinki (FI); Lauri Rauhanen, Helsinki (FI)

(73) Assignee: Nokia Corporation, Espoo (FI)

(21) Appl. No.: 13/050,568

(22) Filed: Mar. 17, 2011

Related U.S. Application Data
(60) Provisional application No. 61/437,933, filed on Jan. 31, 2011.

(51) Int. Cl. G06F 3/00

(52) U.S. Cl. 715/738

(57) ABSTRACT

An approach is provided for enhancing presentment of content data. The content personalization platform determining one or more data categories for presentation in a user interface of a device. The content personalization platform also determines use information associated with the one or more data categories, one or more items within the data categories, or a combination thereof. Then, the content personalization platform then processes and/or facilitates a processing of the use information to determine proportions of the user interface for presenting one or more of the data categories.

### RELATED APPLICATIONS

This application claims the benefit of the earlier filing date under 35 U.S.C. §119(e) of U.S. Provisional Application Ser. No. 61/437,933 filed Jan. 31, 2011, entitled “Method and Apparatus for Enhancing User Based Content Data,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of development has been enhancing a customer's ability to purchase goods and services by way of the mobile device. For example, today's network ready devices can be utilized to browse the Internet, access an online store featuring select goods and services, initiate the purchase and payment process and arrange for delivery, pickup, download and even activation in a matter of minutes. Recognizing the growing interest in online purchasing as well as the upside profit potential, many retailers host physical and virtual store locations, where users may purchase items of interest. As mobile device users interact with content of this nature, however, they are limited in their ability to customize the mode and means of presentment of the content. Typically, the user must settle for whatever content the provider makes available to them, even in cases where the user tends to interact more or less with certain content versus others. Unfortunately, there is no convenient means by which a user may be presented with content data based on their level of interaction, preference or use of the content.

### SOME EXAMPLE EMBODIMENTS

Therefore, there is a need for an approach for effectively enhancing the presentment of content data.

According to one embodiment, a method comprises determining one or more data categories for presentation in a user interface of a device. The method also comprises determining use information associated with the one or more data categories, one or more items within the data categories, or a combination thereof. The method further comprises processing and/or facilitating a processing of the use information to determine proportions of the user interface for presenting one or more of the data categories.

According to another embodiment, an apparatus comprises at least one processor, and at least one memory including computer program code, the at least one memory and the computer program code configured to, with the at least one processor, cause, at least in part, the apparatus to determine one or more data categories for presentation in a user interface of a device. The apparatus is also caused to determine use information associated with the one or more data categories, one or more items within the data categories, or a combination thereof. The apparatus is further caused to process and/or facilitate a processing of the use information to determine proportions of the user interface for presenting one or more of the data categories.

According to another embodiment, a computer-readable storage medium carries one or more sequences of one or more instructions which, when executed by one or more processors, cause, at least in part, an apparatus to determine one or more data types of content associated with a device. The apparatus is also caused to determine use information associated with the one or more data categories, one or more items within the data categories, or a combination thereof. The apparatus is further caused to process and/or facilitate a processing of the use information to determine proportions of the user interface for presenting one or more of the data categories.

According to another embodiment, an apparatus comprises means for determining one or more data categories for presentation in a user interface of a device. The apparatus also comprises means for determining use information associated with the one or more data categories, one or more items within the data categories, or a combination thereof. The apparatus further comprises means for processing and/or facilitating a processing of the use information to determine proportions of the user interface for presenting one or more of the data categories.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based, at least in part, on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enhancing the presentment of content data, according to one embodiment;

FIG. 2 is a diagram of the components of a content personalization platform, according to one embodiment;

FIGS. 3 and 4 are flowcharts of processes for enhancing the presentment of content data, according to various embodiments;

FIGS. 5A-5B are diagrams of user interfaces utilized in the processes of FIG. 3 and/or FIG. 4, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for enhancing the presentment of content data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “content” may refer to any data included or associated with a device, including dynamic content, actionable content, static content, etc. Although various embodiments are described with respect to mobile devices, it is contemplated that the approach described herein may be used with any type of device including, but not limited to, televisions, gaming consoles, appliances, automobiles, personal computers (PCs), workstations, servers, mainframes, supercomputers, or a combination thereof.

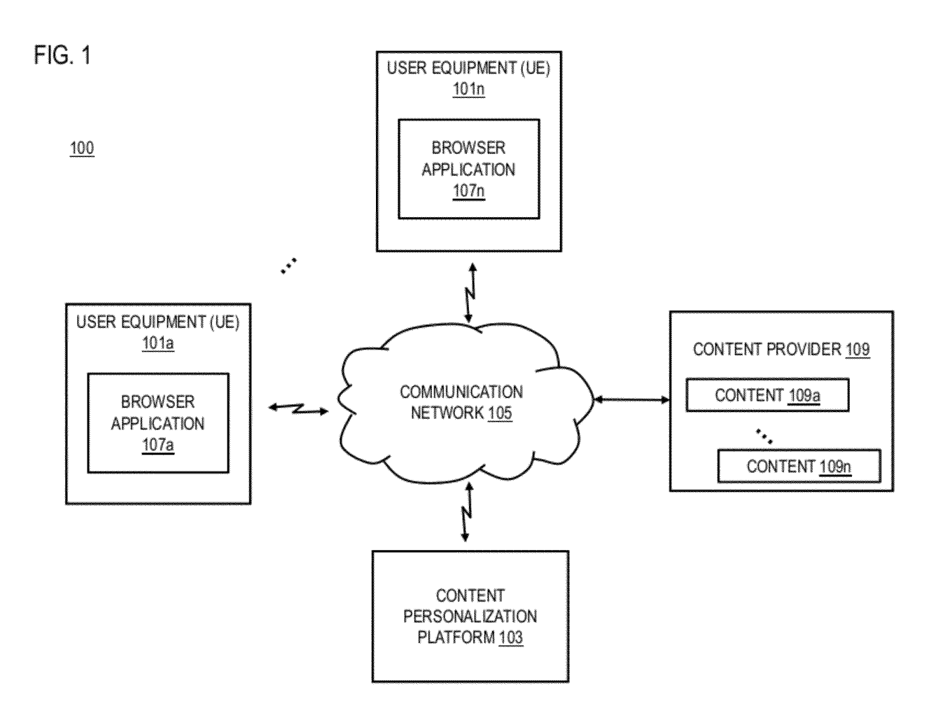

FIG. 1 is a diagram of a system capable of enhancing the presentment of content data, according to one embodiment. Due to recent technological advances, it has been increasingly popular to utilize mobile devices, such as mobile phones, to accomplish many tasks previously monopolized by other non-mobile devices. Such tasks include allowing users to browse the Internet, run sophisticated applications, play games, music, and movies, capture audio, images, or video, read books, communicate with others, store thousands of data files, etc. Due the growing use and range of capabilities and features of mobile devices, many retailers have come to realize that enabling users to interact with their products, brand or content via online means can enhance their presence and long-term revenue prospects. Therefore, many retailers offer online product stores, applications, portals, social networking tools, online communities and other content intended to induce the customer to frequent their site, promote their brand, make purchases, connect with or recommend friends, etc.

By way of example, a user may register with a wireless communication services provider's online store, where they are allowed to browse through selections of applications to purchase and download to their mobile device, update their contacts, browse and share pictures, modify their device settings, update data feeds and perform various other actions related to their mobile device. Typically, the content presented to the user is driven primarily by the online provider, albeit the site may be configured in very limited ways by the user. For example, the user may be able to customize the appearance of their homepage, establish a content update frequency or scheme or other options. However, the general appearance of content, including positioning, formatting, and arrangement thereof respective to the user is confined to what the content provider prefers. Consequently, the user must settle for whatever is presented to them even in instances where they tend to interact with other features or content more than others. For example, they may interact more with their photo viewer than they do a recent news viewer, or may interact more with content (e.g., applications) they added to their personal folder (e.g., “My Folder”) more than their contact list. Users have no way of enabling their preferred content to be enhanced or embellished relative to content that is selected for display by the content provider.

To address this problem, a system 100 of FIG. 1 introduces the capability for users to be automatically presented with content data based on their level of interaction, preference or use of said content. In certain embodiments, “user generated content data,” which pertains to content selected by, used by or preferred by the user may be embellished, highlighted or otherwise enhanced relative to “store recommended content” or “provider content,” which pertains to content driven by the store, content provider, etc. Enhancing of the content may include adapting or optimizing a size of specific content to be rendered to a display of user equipment (UE) 101a-101n, an order of presentment of specific content to be rendered, an extent of interactivity associated with specific content to be rendered, or the like. It is noted that the “user generated data” and “provider content,” while both being associated with provider content, are representative of distinct categories of content data available for presentment to a display of a UE 101. By way of example, the data categories may be determined based on file extensions (e.g., .jpg, .exe, .html, etc.), user-defined or predefined tags (e.g., messaging, music, temporary files, contacts, notes, bookmarks, applications, photos, videos, etc.), or other labelling approaches.

Specifically, the system 100 may present representations of the data categories to a browser application 107a-107n of respective user equipment (UE) 101a-101n based on use information determined for a user respective to the categories of data. In certain embodiments, “use information” pertains to any data for characterizing a user's level of interaction with, preference for or history of use of particular categories of content or portions thereof. By way of example, if a user history analysis reveals that a user tends to access a particular portion of provider content regularly, this tendency may be maintained as use information by the system, and particularly a content personalization platform 103. Based on the use information, the content personalization platform 103 of system 100 may be caused to present representations of content based on the use information, and subsequently adapt the graphical characteristics, textual characteristics, audio characteristics, haptic characteristics, or other characteristics of the display relative to the determined user preference.

In one embodiment, the system 100 also enables content to be presented in an enhanced manner based on the detection of one more updates to the use information. By way of example, the proportions of the browser application 107 for presentment of user generated content is enhanced or expanded in response to a detected user preference for sports related content over finance related content. As another example, an update to a user's “My Applications” folder, viewer, wish list or shopping cart (e.g., user generated content) to reflect a recent application purchase or intent to purchase may result in enhanced presentment of the folder, viewer, wish list or shopping cart relative to provider content. Of note, the proportions of the user interface may decrease if the use information indicates decreased use of the one data category and increase if the use information indicates increased use of the one data category.

In one embodiment, a recommended data category may also be presented to a display of the UE 101a-101n, such as by way of a browser application 107a-107n. By way of example, user information may be processed by the content personalization platform 103 to generate one or more recommended items. The recommended items may include suggested products, services, brands, companies, contacts, actions and other content as generated through analysis of use information for enticing a user action (e.g., purchase). As will be discussed more fully later, a recommendation engine, algorithm or other mechanism may operate in connection with, or result in generation of, use information for enabling user specific recommendations. Of note, the proportions of the user interface for presentment of recommendations may increase or decrease depending on the use information, the availability of suitable/matching recommendations, or a combination thereof.

As shown in FIG. 1, the system 100 comprises a user equipment (UE) 101 or multiple UEs 101a-101n (or UEs 101) having connectivity to a content personalization platform 103 via a communication network 105. The UE 101 may include or have access to a browser application 107 to provide the user of the UE 101 with means for downloading, accessing and/or presenting content as generated by a provider. For example, the browser application 107 may be implemented as a web portal or other application for referencing specific content 109a-109n made available over the network 105 by a content provider 109. As noted, while the content 109a-109n or portions thereof is maintained by the content provider 109 or third-party content provider (not shown), successive interaction with the content 109a-109n by a user results in generation of user generated content. The user generated content may be generated in response to execution of an action by the user, entry of information, registration for a service, etc. Also, the UE 101 may store or access content 109a-109n or portions thereof locally or by way of a remote data store available the UE 101 from over the communication network 105.

The communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

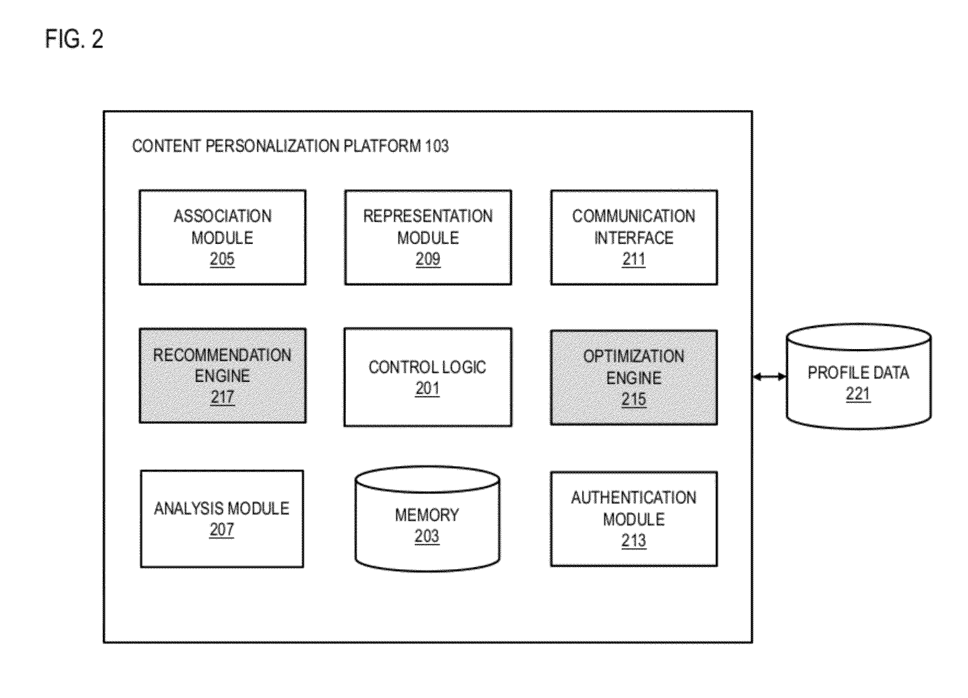

FIG. 2 is a diagram of the components of a content personalization platform 103, according to one embodiment. By way of example, the content personalization platform 103 includes one or more components for enhancing the presentment of content data. It is contemplated that the functions of these components may be combined in one or more components or performed by other components of equivalent functionality. In this embodiment, the platform 103 includes control logic 201, memory 203, an association module 205, an analysis module 207, a representation module 209, a communication interface 211, an authentication module 213, an optimization engine 215 and a recommendation engine 217. The platform 103 also access a profile database 221 for maintaining use information, user profile data and any other data for indicating specific user preferences, history, content use statistics, etc.

The control logic 201 executes at least one algorithm for executing functions of the content personalization platform 103. For example, the control logic 201 interacts with the association module 205 to determine the one or more data types of content associated with the UE 101. As discussed, the determination may be based on file extensions (e.g., .jpg, .exe, .html, etc.), user-defined or predefined tags (e.g., messaging, music, temporary files, contacts, notes, bookmarks, applications, photos, videos, etc.), or other labelling systems. The content categories determined by the association module 205 may include user generated content or provider content. In one embodiment, the content category may include third party provider content, such as for enabling presentment of recommendations, data and items associated with the user on behalf of the provider (e.g., sports score data as provided by a sports content provider). The control logic 201 may then store or update the one or more data types, for instance, in a table in the memory 203 for future use.

The control logic 201 also directs the analysis module 207 to determine use information associated with the one or more determined data categories or one or more items within the data categories. In doing so, the analysis module 207 may account for other factors, including preference data, history data, registration data and other information maintained as profile data 221. In addition, the analysis module may account for relative content data sizes and dimensions, such as to provide feedback for enabling effective presentment of enhanced content by the representation module 209 and optimization engine 215.

The control logic 201 works with the representation module 209 to present one or more representations of the one or more categories of content based on the use information as determined by the analysis module 207. As provided, the representation module 209 may process the use information to determine appropriate characteristics for the one or more representations. These characteristics may include graphical characteristics, textual characteristics, audio characteristics, haptic characteristics, or other characteristics. Furthermore, the content may be adapted for representation to the display of UEs 101, the representation including increasing or decreasing proportions of the user interface associated with one of the one or more data categories.

The representation module 209 is configured to optimize the positioning, proportioning, ordering, provisioning and allocating of content based, at least in part, on the determined use information—i.e., user defined preferences, use history and content interaction tendencies. By way of example, the representation module can optimize/modify the location, proportion or order of provided content, the formatting of provider content and other display characteristics, so as to result in a magnified or more prevalent view of user generated content. The optimization engine 215 may operate in connection with the representation module 209 for enabling the content to be optimally customized respective to differing UEs 101 functional characteristics, operating systems and browser 107 capabilities.

The control logic 201 also utilizes the communication interface 211 to communicate with other components of the UE 101, other UEs 101 and other components of the system 100. The communication interface 211 may include multiple means of communication. For example, the communication interface 211 may communicate via the network 105 by way of SMS, Internet protocol, instant messaging, voice sessions (e.g., via a phone network), or other types of communication.

The control logic 201 further employs the recommendation engine 217 to periodically compiles content indicative of user preferences, including content related to items available for purchase, content available for view, etc. In certain implementations, the recommendation engine 207 may compare user profile data 221 to some of the determined (e.g., collected) use information as generated by the analysis module 207 so as to generate a rating or prediction of the likelihood of a user having an interest in content they had not yet considered, an interest in data they historically viewed, an interest in a specific genre or category of content.

The control logic 201 further employs the authentication module 213 to authenticate users and UEs 101a-101n for interaction with the content personalization platform 103. By way of example, the authentication module 213 receives a request to subscribe to the content personalization service for enhancing the presentment of content data. The subscription process may include enabling general content preferences, subscription levels, etc, which are handled by the authentication module 201. Preferences and settings information may be referenced to a specific user, UE 101, one or more other UEs, or a combination thereof, and maintained as profile data 221.

While not shown, various monitoring systems may be accessed by the content personalization platform 103 for detecting current data traffic levels, error conditions, data exchange rates, network latencies, resource allocation levels and other conditions associated with the operation of the.

The above presented modules and components of the content personalization platform 103 can be implemented in hardware, firmware, software, or a combination thereof. Though presented as a separate entity, in certain embodiments, the content personalization platform may be implemented for direct operation by respective UEs 101a-101n. As such, the content customization platform 103 may generate direct signal inputs by way of the operating system of the UE for interacting with the browser application 107 and accessing content 109a-109n. In another embodiment, one or more of the modules 201-221 may be implemented for operation by respective UEs while other executions are provided by a platform 103.

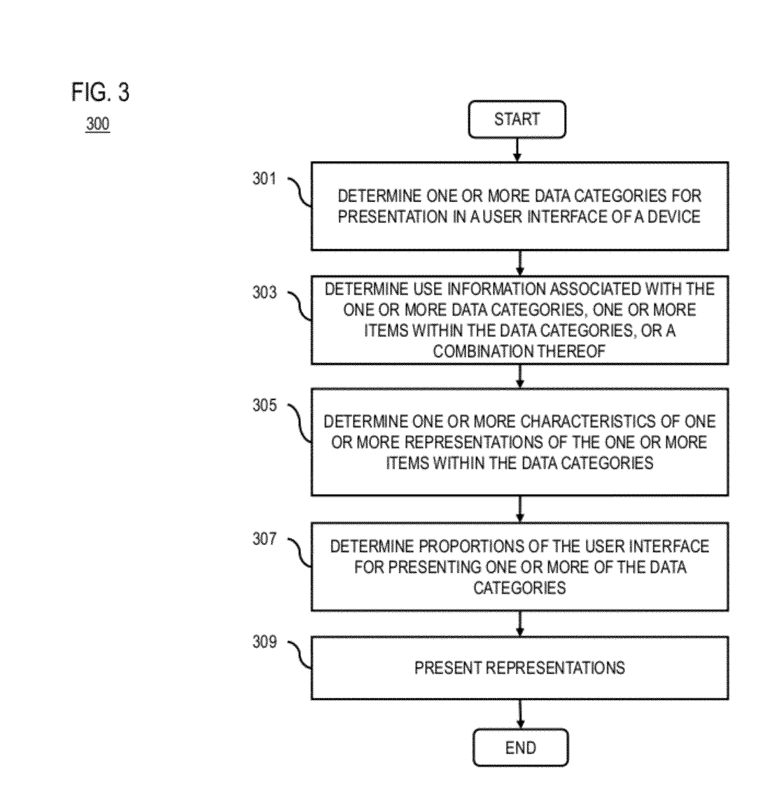

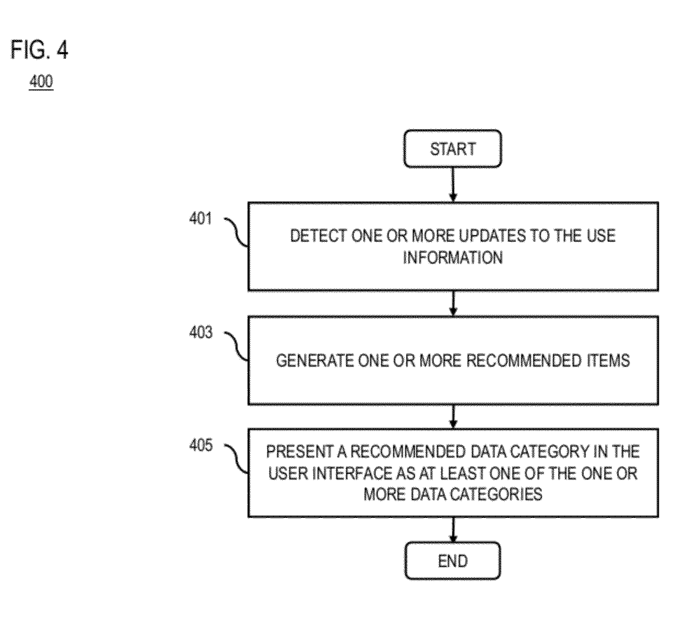

FIGS. 3 and 4 are flowcharts of processes for enhancing the presentment of content data, according to various embodiments. For the purpose of illustration, the processes are described with respect to FIG. 1. It is noted that the steps of the process may be performed in any suitable order, as well as combined or separated in any suitable manner. In step 301 of process 300, the content personalization platform 103 determines one or more data categories for presentation in a user interface of a device. In another step 303, the platform 103 determines use information associated with the one or more data categories, one or more items within the data categories, or a combination thereof. As mentioned, the data categories include user generated data and provider recommended data. In certain embodiments, the data categories may also pertain to provider accepted third party content or recommended content.

Per step 305, the content personalization platform 103 determines one or more characteristics of one or more representations of the one or more items within the data categories. The one or more characteristics may include a size of the one or more representations, an order of the one or more representations, an extent of interactivity associated with one or more representations, or a combination thereof. The extent of interactivity may be determined with respect to actionable content, i.e., a link, action button, mouse over, anchor or any other object data, reference data or other content suitable for executing or invoking one or more actions. By way of example, “actionable” content may be rendered “inactive” by the content personalization platform 103 pursuant to determined use information.

In step 307, the content personalization platform 103 determines proportions of the user interface for presenting one or more of the data categories. By way of example, the proportion may be determined by the content personalization platform in accordance with a usage proportionality algorithm; wherein the percentage of use of user generated content is considered to appropriate the use of and placement of content to the display. Under this scenario, if it is determined the user makes use of certain applications, links or other content presented to their login homepage 51% of the time, the display may be adapted to render a displayable area commensurate with this percentage use of the content. It is noted that device, operating system, browser capabilities and other factors must be considered in generating the appropriate proportion of the user interface. Per step 309, the content personalization platform 103 presents the one or more representations in the user interface based, at least in part, on the one or more characteristics.

In step 401 of process 400 of FIG. 4, the content personalization platform 103 causes the content personalization platform to detect one or more updates to the use information. By way of example, a direct adaptation of user profile information or a change in user behavioral characteristics may be cause for update to the user information. The determination of the proportions of the user interface is initiated based on a detection of the one or more updates.

Per step 403, the content personalization platform 103 processes the determined (or updated) use information to generate one or more recommended items. In another step 405, the UE 101 is caused, by the platform 103, to present a recommended data category in the user interface as at least one of the one or more data categories. In another step 405, the recommendations may be displayed to the user interface as one or more of the data categories. It is noted that the proportions of the user interface associated with one of the one or more data categories decreases if the use information indicates decreased use of the one data category. Conversely, the proportions of the user interface associated with the one data category increases if the use information indicates increased use of the one data category. This functionality is also applicable to the use of, or acceptance of, recommendations.

It is noted that the above steps may be carried out by the content personalization platform 103, by the one or more UEs 101a-101n, by interaction between the platform 103 and the UEs 101a-101n, or a combination thereof. In certain embodiments, the use information is determined based on the device, a user of the device, one or more other devices or one or more other users of the one or more other devices. In another embodiment, the one or more other devices or one or more other users is based on social networking information associated with the device or the user of the device. It is contemplated that the processes herein may be applied in instances where the UEs 101a-101n share content with one another independent of, or without connection to, a content provider 109.

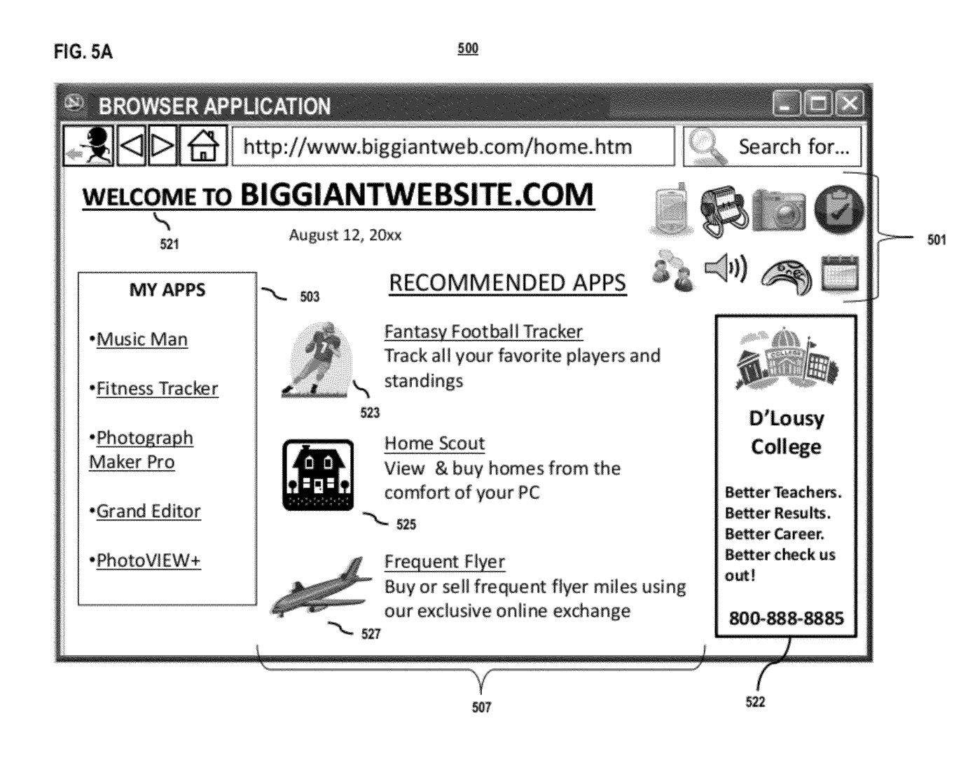

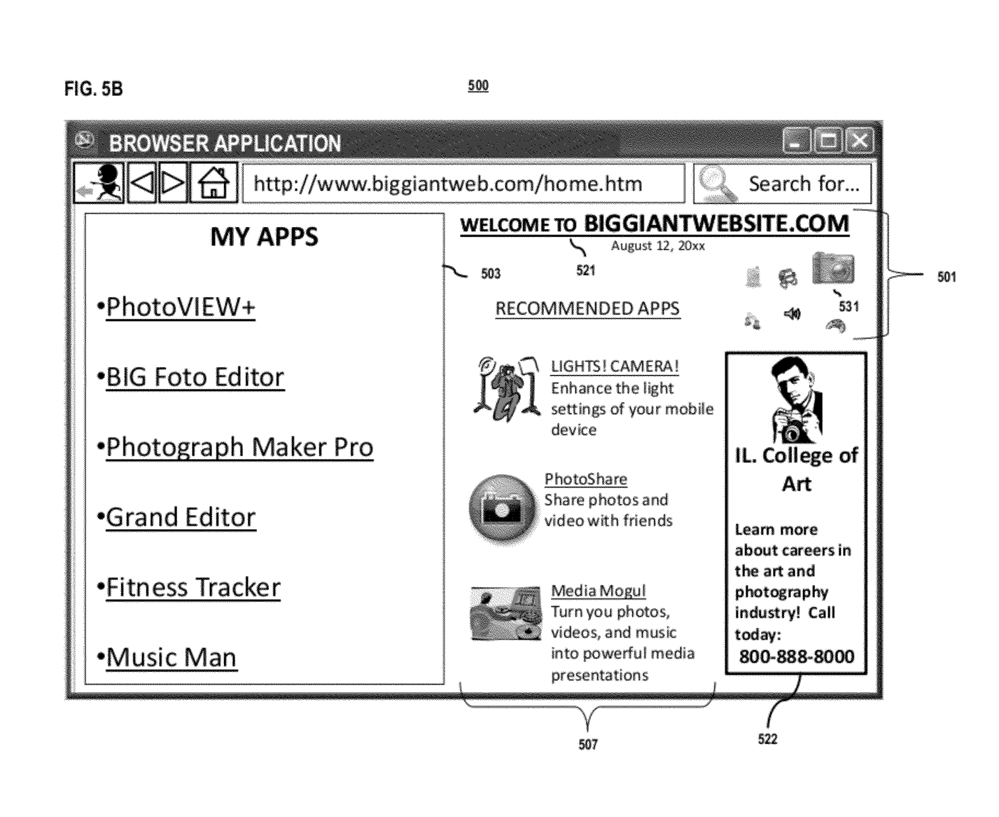

FIGS. 5A-5B are diagrams of user interfaces utilized in the processes of FIG. 3 and/or FIG. 4, according to various embodiments. For the purpose of illustration, the diagrams are described with respect to an exemplary use case of a user of UE 101 accessing provider content by way of a browser application 500. The content provider, in this example, is a retailer of mobile device applications. The provider's online store is named “BigGiantWebsite.com.” In addition to offering applications and other device products, the provider content also includes a suite 501 of tools made available for use by registered users. By way of example, the suite 501 of tools is represented by various icons and includes a contact application, a calendar application, a task application, a picture viewer application, a chat or social networking application, a media player application and a game console application. The icons are representative of actionable content, wherein upon selection of an icon, the related application may be initiated or invoked.

The provider content displayed via the browser application 500 also includes various types of data, corresponding to different categories. It is noted that the suite 501 of tools, banner information 521, advertisement 522 and “Recommended Apps Viewer” 507 are examples of provider content. Another category of provider content includes recommended data, which is presented to the display as a “Recommended Apps Viewer” 507. As noted previously, the recommendations may be generated by a recommendation engine of the content personalization platform 103, and presented based at least in part on use information. By way of example, the recommendations include a football related application 523, a real estate tracking application 525 and a travel related application 527.

Another category of content data includes user generated content in the form of a “My Apps Viewer” 503, which features data representative of content selected by the user for purchase. By way of example, the viewer 503 displays various applications purchased by the user over a period of time, the listing including a music application, fitness tracking application, two photography related applications, and an editing tool. It is noted with respect to the example herein that the apps are listed in order of purchase. It is further noted that the “My Apps Viewer” 503 may support drag and drop purchasing of applications.

A comparison of the applications in the “My Apps Viewer” 503, representative of user generated content, and the provider content 507, 501, 521 and 522 shows a disconnect between the user's interest in photography content and the recommendations. Also, the advertisement 522 is unrelated to the specific interests of the user. Furthermore, the proportion of space occupied within the browser by the “My Apps Viewer” 503 is small in comparison to that occupied by the suite 501 of tools, banner information 521, advertisement 522 and “Recommended Apps Viewer” 507. From this example, it is observed that the user generated content is the most frequently used and deemed of interest to the user, but occupies the least proportion of the browser based interface.

In response to the disproportionate presentment of provider content, the content personalization platform 103 automatically generates an enhanced representation of the content, as depicted in FIG. 5B. By way of example, the “My Apps Viewer” is shown to comprise a larger proportion of the user interface 500. In addition, the format of the textual data indicating the various applications is larger and more prominent. In certain embodiments, the “My Apps Viewer” 503 occupies greater space within the browser due to determined use information indicating the user interacts most with this content. In another embodiment, the “My Apps Viewer” 503 may dynamically increase in proportion in response to the addition of more user generated/selected content. By way of example, this may occur when the user adds an additional application entitled “BIG Foto Editor” to their list of applications. Given the user's interest in photography related content, and frequent use of the picture viewer application 531 available in the suite 501 of tools, the icon representative of this application is also featured more prominently than the other representative icons, which are presented in reduced form.

In addition to the above, the order of representation and placement of content within the “My Apps Viewer” 503 is modified to present the applications based on a user determined order of use, priority or preference. By way of example, the “PhotoView+” application represents the most frequently used application by the user, while “Big Foto Editor” and “Photograph Maker Pro” represent the second most widely used applications. In keeping with the example, all of the applications pertaining to photography are ordered in the list accordingly, while the other applications are featured in further descending order. Alternatively, the other non-photography related applications listed in the viewer 503 could be decreased in size, disabled, shaded out/whitewashed, etc. for indicating their lower use by the user.

Under this scenario, the “Recommended Apps Viewer” 507 is also modified such that it occupies significantly less real estate/space/proportion of the browser 500 interface in comparison with the “My Apps Viewer” 503. In addition, the applications recommended are photography related content in alignment with the user's interests. It is further shown that the banner information 521 is reduced in size and reoriented (shifted to the right) to accommodate the enhanced representation of the “My Apps Viewer 503. Still further, the advertisement 522 is adapted to feature content pertaining to an art school, which is related to the user determined interest in photography related content.

By way of example with respect to FIGS. 5A and 5B, the content personalization platform 103 enabled the user generated content (e.g., “My Apps Viewer” 503) to be featured to the display more prominently than the provider content (e.g., the suite 501 of tools, banner information 521, advertisement 522 and “Recommended Apps Viewer” 507). Of note, however, the content enabled for enhancement may vary across respective portions of the interface, such as in the case of the placement of the picture viewer application 531 relative to the “My Apps Viewer” 503. In certain embodiments, the capabilities set forth herein may be established for automated execution or disabled at the request of the user, service provider or a combination thereof.

It is noted that the exemplary techniques and system presented herein enables convenient, seamless adaptation or generation of content for optimized presentment to display of a user device. The exemplary techniques also support enhanced presentment of content based on use information pertaining to a user of the device. The processes described herein for enhancing the presentment of content data may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

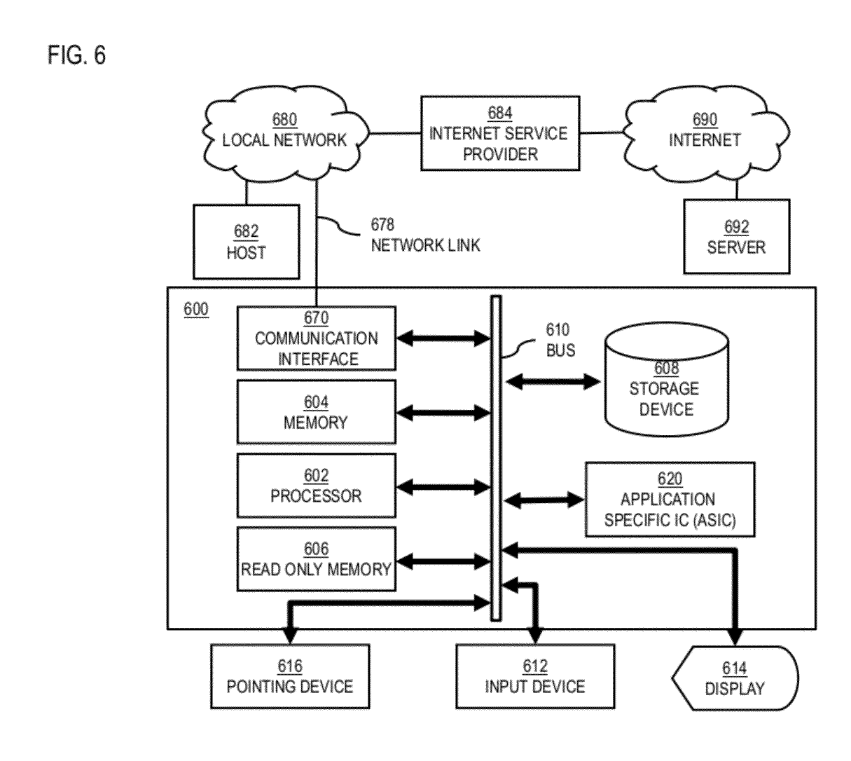

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to enhance the presentment of content data described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of enhancing presentment of content data.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to enhance presentment of content data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for enhancing presentment of content data. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for enhancing presentment of content data, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for enhancing the presentment of content data to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

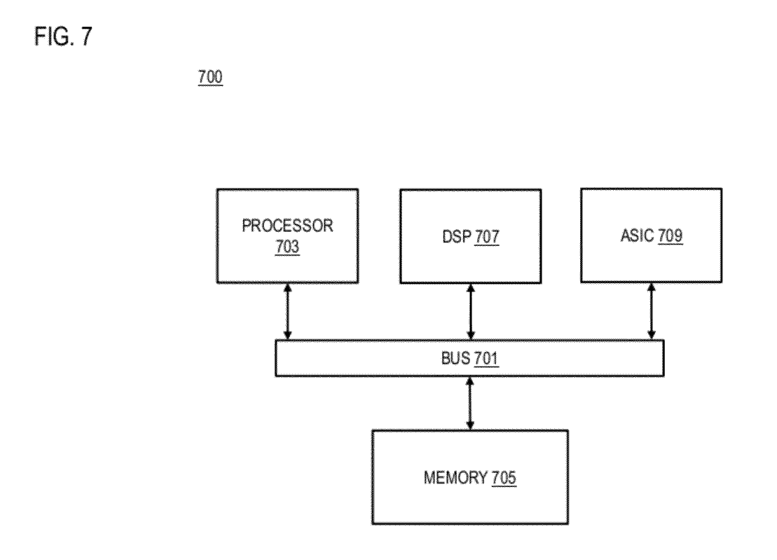

FIG. 7 illustrates a chip set or chip 700 upon which an embodiment of the invention may be implemented. Chip set 700 is programmed to enhance the presentment of content data described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of enhancing the presentment of content data.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to enhance presentment of content data. The memory 705 also stores the data associated with or generated by the execution of the inventive steps.

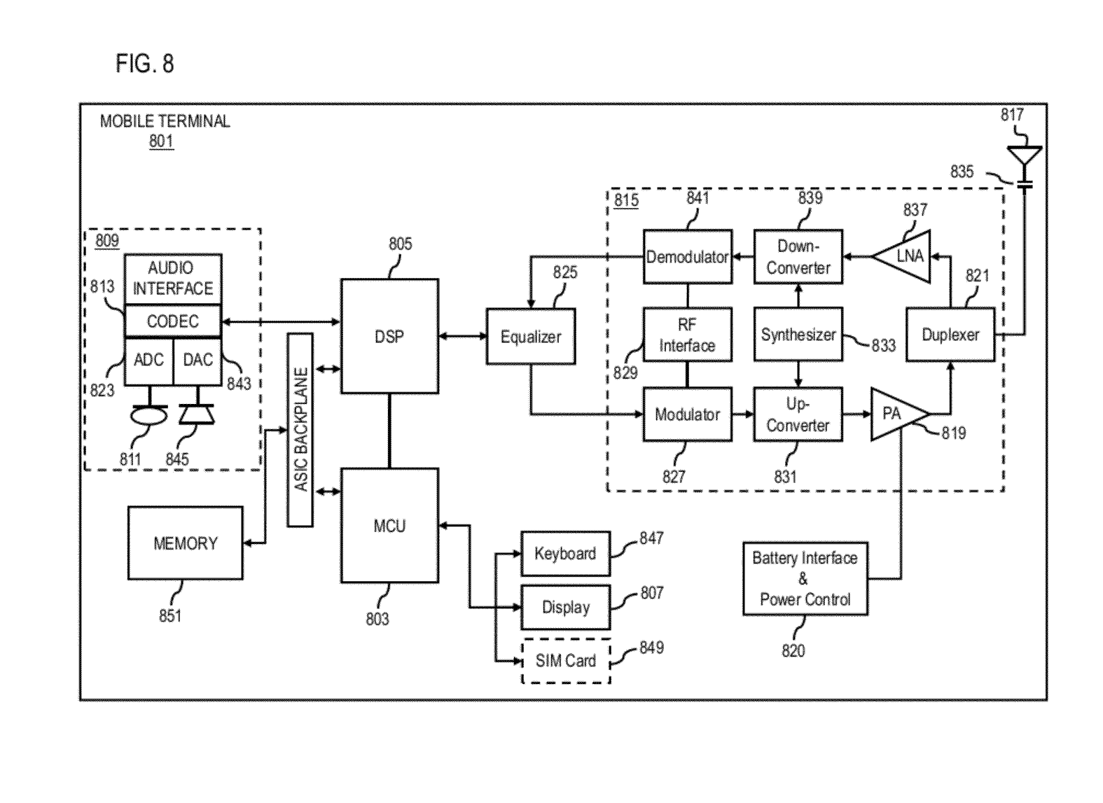

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of enhancing presentment of content data. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of enhancing presentment of content data. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to enhance the presentment of content data. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
one or more data categories for presentation in a user interface of a device;
use information associated with the one or more data categories, one or more items within the data categories, or a combination thereof;
a processing of the use information to determine proportions of the user interface for presenting one or more of the data categories.

2. A method of claim 1, wherein the (1) data and/or (2) information and/or (3) at least one signal are further based, at least in part, on the following:
a processing of the use information to determine one or more characteristics of one or more representations of the one or more items within the data categories; and
at least one presentation of the one or more representations in the user interface based, at least in part, on the one or more characteristics.

3. A method of claim 2, wherein the one or more characteristics include, at least in part, a size of the one or more representations, an order of the one or more representations, an extent of interactivity associated with one or more representations, or a combination thereof.

4. A method of claim 1, wherein the user interface is associated with provider content, and the one or more data categories include, at least in part, user generated data and provider recommended data.

5. A method of claim 1, wherein the (1) data and/or (2) information and/or (3) at least one signal are further based, at least in part, on the following:
at least one detection of one or more updates to the use information,
wherein the determination of the proportions of the user interface is initiated based, at least in part, on a detection of the of the one or more updates.

6. A method of claim 1, wherein the (1) data and/or (2) information and/or (3) at least one signal are further based, at least in part, on the following:
a processing of the use information to generate one or more recommended items; and
at least one presentation of a recommended data category in the user interface as at least one of the one or more data categories.

7. A method of claim 1, wherein the proportions of the user interface associated with one of the one or more data categories decreases if the use information indicates decreased use of the one data category, and wherein the proportions of the user interface associated with the one data category increases if the use information indicates increased use of the one data category.

8. A method of claim 1, wherein the use information is determined based, at least in part, a the device, a user of the device, one or more other devices, one or more other users of the one or more other devices, or a combination thereof.

9. A method of claim 8, wherein the one or more other devices, the one or more other users, or a combination thereof is based, at least in part, on social networking information associated with the device or the user of the device.

10. A method of claim 1, wherein the user interface is associated with a personal information management application including, at least in part, a contact application, a calendar application, a task application, or a combination thereof.

11. An apparatus comprising:
at least one processor; and
at least one memory including computer program code for one or more programs,
the at least one memory and the computer program code configured to, with the at least one processor, cause the apparatus to perform at least the following,
determining one or more data categories for presentation in a user interface of a device;
determine use information associated with the one or more data categories, one or more items within the data categories, or a combination thereof;
process and/or facilitate a processing of the use information to determine proportions of the user interface for presenting one or more of the data categories.

12. An apparatus of claim 11, wherein the apparatus is further caused to:
process and/or facilitate a processing of the use information to determine one or more characteristics of one or more representations of the one or more items within the data categories; and
cause, at least in part, presentation of the one or more representations in the user interface based, at least in part, on the one or more characteristics.

13. An apparatus of claim 12, wherein the one or more characteristics include, at least in part, a size of the one or more representations, an order of the one or more representations, an extent of interactivity associated with one or more representations, or a combination thereof.

14. An apparatus of claim 11, wherein the user interface is associated with provider content, and the one or more data categories include, at least in part, user generated data and provider recommended data.

15. An apparatus of claim 11, wherein the apparatus is further caused to:
cause, at least in part, a detection of one or more updates to the use information,
wherein the determination of the proportions of the user interface is initiated based, at least in part, on a detection of the of the one or more updates.

16. An apparatus of claim 11, wherein the apparatus is further caused to:
process and/or facilitate a processing of the use information to generate one or more recommended items; and
cause, at least in part, presentation of a recommended data category in the user interface as at least one of the one or more data categories.

17. An apparatus of claim 11, wherein the proportions of the user interface associated with one of the one or more data categories decreases if the use information indicates decreased use of the one data category, and wherein the proportions of the user interface associated with the one data category increases if the use information indicates increased use of the one data category.

18. An apparatus of claim 11, wherein the use information is determined based, at least in part, a the device, a user of the device, one or more other devices, one or more other users of the one or more other devices, or a combination thereof.

19. An apparatus of claim 18, wherein the one or more other devices, the one or more other users, or a combination thereof is based, at least in part, on social networking information associated with the device or the user of the device.

20. An apparatus of claim 11, wherein the user interface is associated with a personal information management application including, at least in part, a contact application, a calendar application, a task application, or a combination thereof.
